(19) United States
(12) Patent Application Publication
(10) Pub. No.: US 2008/0036612 A1
(43) Pub. Date: Feb. 14, 2008

(54) System and Method for Tracking, Locating, and Identifying Known Sex Offenders

(76) Inventors: Chad Christopher Koslow, Centreville, VA (US); Brian Kolo, Leesburg, VA (US)

Correspondence Address: Brian A. Kolo, 43586 Purple Aster, Leesburg, VA, 20176, US

(21) Appl. No.: 11/687,631

(22) Filed: May 14, 2007

Related U.S. Application Data
(63) Continuation-in-part of application No. 11/508,993, filed on Aug. 24, 2006.
(60) Provisional application No. 60/710,591, filed on Aug. 24, 2005.

(51) Int. Cl. G08B 23/00

(52) U.S. Cl. 340/573.4

(57) ABSTRACT

The present invention is comprised of a computer system and software used to track, locate, and/or identify sex offenders. The invention is comprised of a computer system, a GPS device carried With a sex offender, and a data storage medium. The system may be capable of notifying authorities when the sex offender enters forbidden areas such as schools, cities, counties, states, countries, or other regions designated as denied to the sex offender.

### RELATED APPLICATIONS

This application is a continuation in part of U.S. Ser. No. 11/508993 filed Aug. 24, 2006, currently pending, which is a continuation of U.S. Ser. No. 60/71 0591, filed Aug. 24, 2005, now expired.

### BACKGROUND OF THE INVENTION

Numerous studies show that convicted sex offenders are repeat offenders. Compared to non-sex offenders released from State prisons, released sex offenders were 4 times more likely to be rearrested for a sex crime. Sadly, the victims of these offenders are often children. Indeed, offenders themselves report that two-thirds of their victims were under the age of 18, and 58% of the offenders reported that their victims were aged 12 or under.

In an attempt to safeguard the community, a federal law known as “Megan's Law” requires convicted sex offenders to register with the state, and the community be notified if the sex offender is in the local region. Registration of offenders and community notification of the location of registered sex offenders helps assist law enforcement in investigations, deter convicted sex offenders from continuing to commit sex offenses, and offers citizens information they can use to protect children. The States have the primary responsibility for gathering data on offenders and most create a database of sex offenders. Currently, the federal government is sponsoring a National Sex Offender Registry (NSOR) Identification Assistance Program to consolidate all of the States information.

There are numerous problems with the current system. First, searching 51 individual jurisdiction databases is not time effective. Second, the State databases are too large and change too quickly to print out. Third, access to offender information requires an internet connection. Further, manual entry of information while searching is error prone. The NSOR does not solve these problems. The NSOR contains information from less than half the states and is merely a portal to the actual state websites.

### BRIEF SUMMARY OF THE INVENTION

The present invention is directed toward the detection of sex offenders attempting to enter a facility or area where children may be present.

The present invention is also directed to software used to detect sex offenders.

The present invention is also directed to the prevention of sex offender recidivism.

The present invention is also directed to prevent known sex offenders from entering areas such as schools, nurseries, day care centers, zoos, community pools, theme parks, amusement parks, parks, and other areas frequented by children and elderly adults.

The present invention is also directed to automatically updating a remote computer with the current data of known sex offenders.

The present invention is also directed to creating a mobile-based computer solution useful at sporting events or facilities where there is insufficient space to provide a full sized computer.

The present invention is also directed to recording the location and/or movement of a sex offender.

The present invention is also directed to notifying authorities when a sex offender enters a forbidden region.

Local law enforcement agencies are not required to and often do not notify every possible school, organization, business or individual within its jurisdiction. The present invention provides these groups the tools and resources that allow them to identify these offenders. The present invention allows for timely and accurate identification of these individuals without the need of law enforcement.

### DESCRIPTION OF THE FIGURES

FIG. 1 illustrates a system comprising a central system local system and on line state registries.

FIG. 2 is a flowchart showing one possible method of updating a central system with known sex offender personal information.

FIG. 3 is a flowchart showing one possible method of updating a local system with known sex offender personal information.

FIG. 4 is a flowchart showing how a human subject's personal information is compared to the personal information of a known sex offender.

FIG. 5 shows the high level components of the Location System.

FIG. 6 shows the Tracking System in an example of tracking the movements of a Known Offender thorough a city.

FIG. 7 shows one embodiment of the Location System at the level of an entire state.

FIG. 8 provides an example of a GPS Message.

FIG. 9 shows one embodiment of the Location System at the level of a city.

### DETAILED DESCRIPTION OF THE INVENTION

It will be appreciated by those skilled in the art that although the following Detailed Description will proceed with reference being made to preferred embodiments, the present invention is not intended to be limited to these embodiments.

Identification System

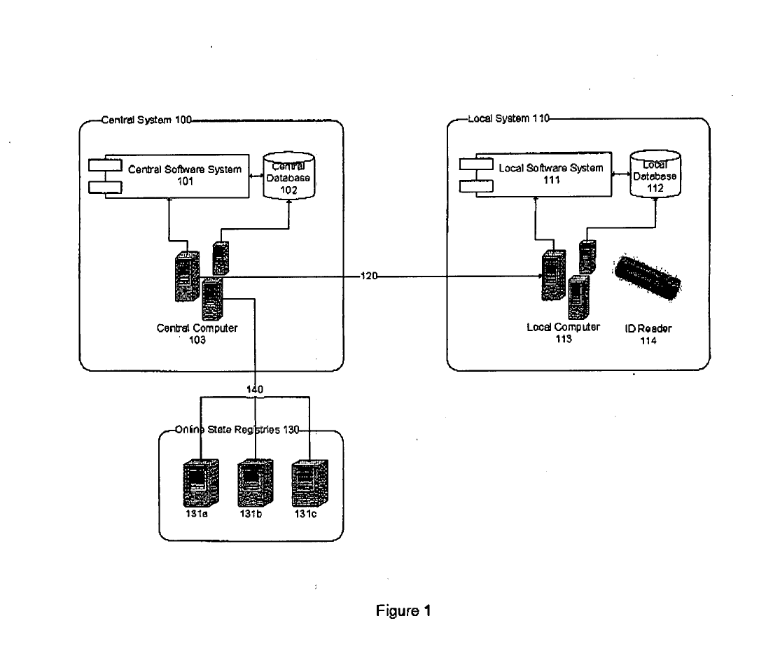

FIG. 1 illustrates one preferred embodiment. The Central System 100 may comprise a Central Software System 101, which is connected by a communication means to a Central Data base 102. The Central System 101 and/or the Central Database 102 may be connected by a communication means to a Central Computer 103.

Further, the Central Computer 103 may be connected by a communication means 140 to Online State Registries 130, which may be located at one or more web addresses 131a, 131b and 131c. Further, the Central Computer 103 may be connected by a communication means to the Local Computer 113 of a Local System 110. The Local System 110 may also further comprise a Local Software System 111 connected by a communication means to the Local Computer 113 and a Local Database 112. The Local Database 112 may also communicate with the Local Computer 113. Further, the Local System 110 may comprise an ID Reader 114.

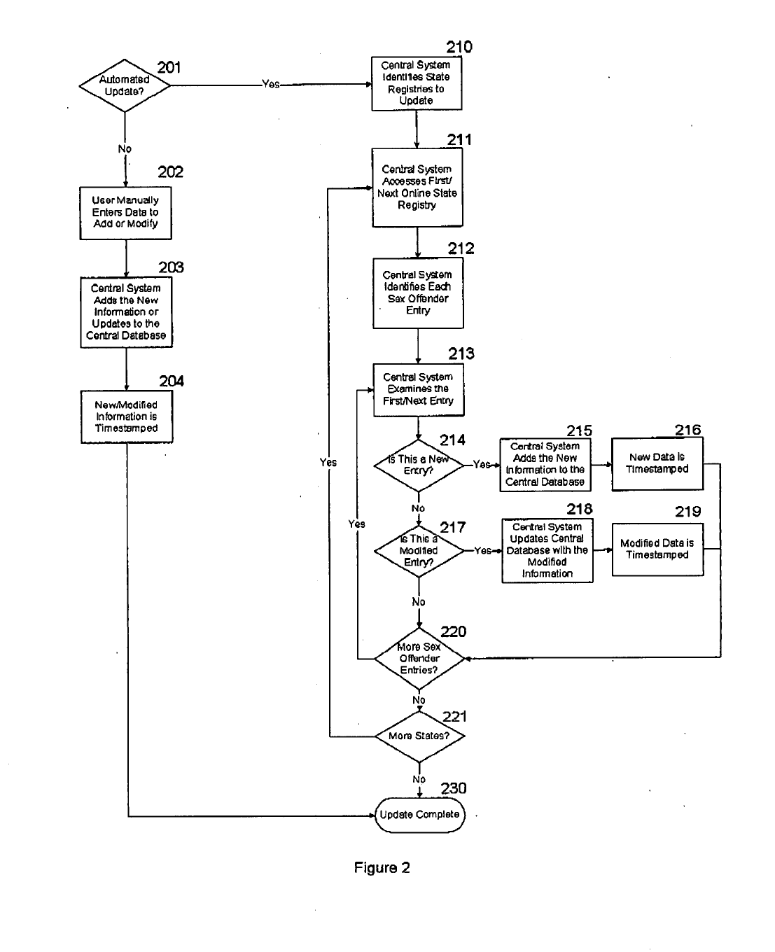

FIG. 2 is a flowchart showing one possible method of updating a Central System with known sex offender personal information. If the system is not capable of an automated update 201, then a user may manually enter new or modified data into the Central System 202. The Central System then adds the new or modified information to a Central Database 203. To track when the information is added to the Central Database, the information is time stamped 204. Once all of the information is entered, the update is complete 230.

If the system is capable of an automated update 201, the Central System identifies state registries to update at 210. This occurs by the Central System accessing first/next online state registries 211. The Central System then identifies each sex offender entry 212. The Central System examines the first/next entry 213 to determine if this entry is currently in the Central System. If the entry is not in the current Central System, the entry is “new” 214.

If the entry is new, the Central System adds the new entry information to the Central Database 215. To keep track of when the information was added to the Central Database, the new data is saved in the Central Database with a time stamp 216. If the entry is not new, then the Central System determines if the entry has been modified since the last Central System update 217.

If the entry is modified, the Central System updates the Central Database with the modified information 218 and the data is saved in the Central Database with a timestamp 219. If the entry is not modified, then the Central System determines if there is any other new or modified sex offender information 220. If there is other new or modified sex offender information, the Central System repeats the steps of 213-219 until the Central System has saved all new or modified sex offender information. If there is not any other new or modified sex offender information, then the Central System determines if there are any other state databases that the Central System needs to search 221. If there is another state database/registry that the Central System has not search, then the Central System goes to the unsearched state database/registry and repeats the steps of 211-220 until the Central System has saved all of the new or modified sex offender information. Steps 211-220 repeats until all state information is saved. The update is then complete 230.

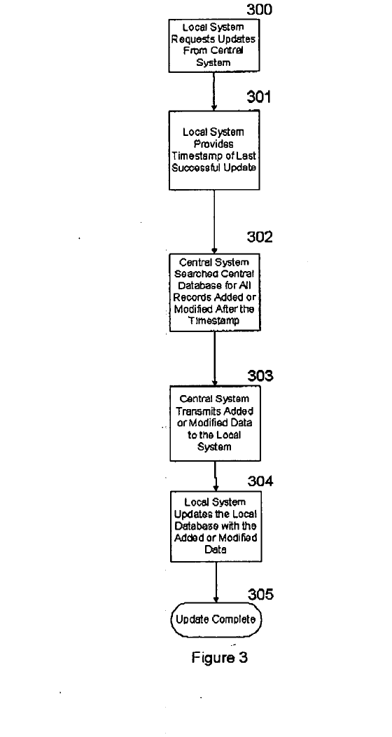

FIG. 3 illustrates how a Local System and Central System may communicate to update the Local System with known sex offender personal information. The Local System first requests an update from the Central System 300. The Local System provides the Central System with a timestamp of the last successful date 301. The Central System then searches the Central Database for all records added or modified after the timestamp 302. The Central System transmits all records, which were added or modified after the timestamp to the Local System 303. The Local System updates the Local Database with the added or modified data 304. Once all new added or modified data is saved to the Local Database, the Update is complete 305.

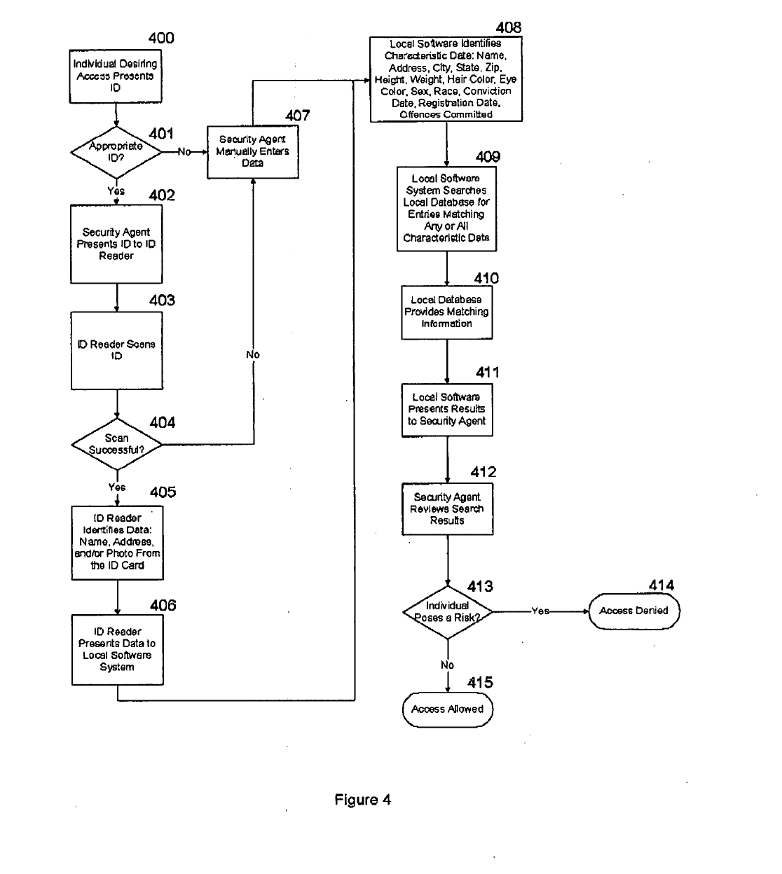

FIG. 4 is a flowchart showing how a human subject's personal information is compared to the personal information of a known sex offender. If a subject wants to enter or access a certain area or building, such as a school, child-play area, and the like, the subject presents some form of identification 400. A security agent must then determine if the identification is an appropriate form 401 for the ID reader. If the identification is appropriate, the security agent presents the identification to an ID reader 402. The ID reader scans the identification 403.

If the scan is successful, the ID reader identifies the subject's personal information such as First Name, Last Name, Address, Photo, and the like 405. The ID reader then presents the data to the local software system 406.

If the scan is not successful at step 404, or if the identification is not appropriate at step 401, or if the ID reader scan is not successful at step 404, then the security agent must manually enter the data 407. Once the data is entered, the local software identifies characteristic data 408. The characteristic data may be any personal information, including but not limited to, the subject First Name, Last Name, Home Address, City, State, Zip, Height, Weight, Hair Color, Eye Color, Sex, Race, Conviction Date, Registration Date, and Offenses Committed. The Local System then searches the Local Database for Entries matching any or all of the characteristic data entered 409. The Local Database provides any characteristic data that matches the subject characteristic data 410. The Local Software presents the matching characteristic data to the security agent 411. The security agent review the search result 412 and determines if the subject poses a risk by comparing the Local Database characteristic data and the subject characteristic data 413. If the subject is a risk, access is denied 414. If the subject is not a risk, access is granted 415.

In the preferred embodiment, the present invention comprises two computer systems, an identification card reader (ID Reader), and two software systems. The first computer system and a first software system (collectively referred to as the Local System) are located at a facility where sex offenders are excluded from entering. Optionally, the Local System can include an ID Reader. The first software system contains a database of known sex offenders. An individual accessing the facility presents an identification card (ID) to a security agent. The security agent presents the ID to the ID Reader. The ID reader determines characteristic data from the ID such as the individuals name and address. The ID Reader then presents the characteristic data to the software system. The software system searches a database (Local Database) for records matching the characteristic data. All potential matches are presented to the security agent, including a photo of the individual found in the database. The security agent then compares the potential matches to the characteristic data from the ID to determine if the individual presenting the ID is present in the database. If the security agent determines the individual poses no risk, the individual is allowed access to the facility. Otherwise, the individual is denied entry to the facility.

In addition present in the preferred embodiment is a second computer system and a second software system (collectively referred to as the Central System). The software system present on this computer system is located at a site remote from the facility under protection. This software system is capable of administrating and updating a database (Central Database) of known sex offenders. The software system is also capable of detecting sex offenders removed from the registry and removing or marking the corresponding entry in the Central Database. On a regular basis, the two computer systems communicate and update the database of known sex offenders on the first computer system. This enables the remote system to reliably contain a current list of known sex offenders.

In the preferred embodiment, the Central System searches all online state sex offender registries each day. If a new individual is identified, that individual's information is added to the Central Database. If an individual's information is modified, that information is updated in the Central Database. If an individual was previously in the Central Database but does not appear in the current registry, that individual is either removed from the Central Database or marked indicating the individual may be removed. Each entry added, updated, or removed is marked with a time stamp indicating the date and time of the addition or modification. Thus, the Central Database contains a current list of all known sex offenders available online.

The Local System uses a means for communicating to connect to the Central System. The Local Database transmits to the Central System a time stamp indicating when the last database update was successfully completed. The Central System transmits to the Local System all information added or updated after the time stamp. Thus, the Local Database contains a current list of all known sex offenders.

Optionally, when the Local System has not received an update from the Central System within a predetermined period of time, the Local System notifies the user that the data contained in the Local System may not be current.

Each state provides various information on sex offenders available in their registries. This information typically includes a first name, middle name, last name, suffix, address, city, state, zip, county, height, weight, sex, age, hair color, eye color, date of convictions, offence committed, date of registration, violation information (if the offender has failed to comply with the registration process) and/or photo. When the Central System executed an online search, all of this information may be collected and/or verified. If an individual has any information different from what was previously in the Central Database, the new information is collected and the Central Database updated. When some of this information is different, the record is considered modified and a time stamp indicating the date and time of the modification is attached to the record.

In the preferred embodiment, the individual desiring access presents a State identification card (State ID), such as a driver's license, to the security agent. The State ID is presented to the ID Reader. The ID Reader scans the State ID and uses object-character recognition (OCR) technology to read the information from the State ID. The ID Reader is designed to identify various elements of the State ID and discover specific information such as a first name, middle name, last name, suffix, address, city, state, zip, type of ID (which state), and photo. The ID Reader then makes this information available to the local software system for further processing.

In the preferred embodiment, a method of doing business may be created by providing a subscription-based service. First, a customer purchases a Local System comprising the first computer system and first software, and optionally the Local Database. After the Local System is set up, the customer must subscribe to a service in order to receive periodic updates for the Local Database:. Optionally, the Local System may be provided at no charge. Furthermore, the Local System may be comprised of only a first computer and first software. In this case, the Local System may use the Central Database as the source of known sex offender information for searching.

Another embodiment of the present invention comprises a second computer system and a second software system (collectively referred to as the (Central System). The second software system is capable of administrating and updating a database (Central Database) of known sex offenders. The Central System works in the same manner as described above. In addition, the Central System nay comprise a third software system (Web Software) which provides web-based access to the data in the Central Database. In this case, a user may connect to the Central System using a means for communicating to search the database based on characteristic data. The Central Database may be located locally or remotely.

The Web Software takes user input including from a user such as first name, middle name, last name, suffix, address, city, state, zip county, height, weight, sex, age, hair color, eye color, date of convictions, offence committed date of registration, and/or violation information (if the offender has failed to comply with the registration process). The Web Software searches the Central Database for records matching some or all of the criteria provided by the user. The Web Software presents all potential matches, including a photo if available, to the user. The user may then manually search the results.

The Web Software may also take as input from the user a city, zip, or latitude longitude location, along with a radius. The Web Software then searches the database, returns all entries matching within the specified radius, and presents the results to the user. Additionally, the user may setup an account entering a city, zip, or latitude longitude location. In this case, the Web Software will periodically search the database and notify the user of sex offenders present within the radius. This notification may include some of all of the following notifications: all sex offenders within this radius, or all new sex offenders found within the radius, or all sex offenders modified within this radius, or all sex offenders who have recently left this radius. In the preferred embodiment, this notification is provided by e-mail and includes a map indicating the location of entries present in the notification.

In this embodiment, a method of doing business may be created by providing database access based on customer subscriptions. Here, a customer initially enters a web site provided by the Web Software. The customer provides parameter limits. For instance, the parameter limit may be location information as a city, state, zip, or latitude longitude location. The parameter limit may also be a radius of the location, selected from the Web Software, typically 5 miles, 10 miles, 50 miles, 100 miles, or the like. The customer may then provide personal information for notification such as an e-mail address, phone number, or pager number. The customer also provides a method of payment such as a credit card number, checking account number, payment by check, payment by money order and the like. Once this information is collected, the Web Software will set up an account. Periodically the Web Software will search based on the parameters provided by the customer. The customer is notified of matches found against these parameters. This notification is made using the notification scheme selected by the user. This service may be provided to the customers based on a periodic subscription, based on the size of the radius selected, and/or based on the number of matches found.

Another embodiment of the present invention the Local System comprises one or more mobile computers. These mobile computers may be capable of internally hosting the Local Database, or they may use any means to communication, including but not limited to wired or wireless network to communicate with the Local Data base.

Location System

Another embodiment of the invention detects the location of people, such as sex offenders, by utilizing a GPS tracking system. The CPS tracking system is comprised of a GPS receiver, and a GPS Device containing a transmitter. The transmitter relays a GPS Message containing the present GPS location of the GPS Device to a receiver. The receiver may be a centrally located receiving station, a plurality of receivers connected by a network, or a cell phone tower reception station.

In the preferred embodiment, the GPS Device is physically attached to a known sex offender, such as an ankle bracelet when an individual is put under house arrest. In this case, the criminal or suspect is individually associated with the GPS Device.

The receiver then relays the present GPS location of the GPS Device to a GPS Location Computer System. The GPS Location Computer System interprets the message relayed and identifies the GPS Device and the present location of the GPS Device. The GPS Device may be identified by a unique value or other identifying information assigned to the GPS Device. This GPS Device ID is then transmitted in the GPS Message from the receiver along.

The GPS Location Computer System may be one of the computer systems as specified Identification System. The GPS Location Computer System may be identified with either the Central System or Local System. Furthermore, the Central database or Local Database may provide a data storage device for recording the transmitted messages.

The GPS Message may contain information in addition to the GPS Device ID of the GPS Device and the present location of the GPS Device. The GPS message may also contain the time the message was sent, a name or ID associated with an individual associated with the GPS Device, and/or an alarm status indicating that the GPS Device has been tampered with.

The GPS Location Computer System interprets and identifies the data sent from the transmitter. In the preferred embodiment, this information is stored in a database. In addition to this data, the time the message was received by the GPS Location Computer System may also be stored. Furthermore, the time the data was entered into the database may also be stored.

The GPS Location Computer System may also analyze the present location of the GPS Device to determine if the GPS Device has entered or is nearing a restricted area. This may be accomplished by associating restricted regions with the GPS Device ID. Alternatively, this may be accomplished by associating restricted regions with other information relayed to the GPS Location Computer System, such as the name or ID of the individual associated with the GPS Device.

In the preferred embodiment, the restricted region is defined by a specific latitude and longitude coordinate position along with a radius. All locations within the specified radius of the position are considered within the restricted region. Alternatively, a restricted region may be defined by three or more non-collinear latitude and longitude coordinate positions. These positions may define polygon representing the boundary of the restricted region. In this embodiment, all points within the polygon are considered within the restricted region.

In the preferred embodiment, the GPS Location Computer System periodically checks the last known location of the GPS Device ,against the restricted regions associated with the GPS Device. If GPS Device is determined to be within a restricted region, an alert is transmitted. The alert is transmitted to a law enforcement official local to the last known location of the GPS Device. This alert contains a message that may include the GPS Device ID, the last known location of the GPS Device, the time of the last known position of the GPS Device, and the name of an individual associated with the GPS Device.

In less preferred embodiments, the alert message may be transmitted to a known offender or a victim of the known offender.

In addition an alert may be sent when the last known location of the GPS Device is located within a specified distance of a restricted region. Here, the alert may act as a warning. In the preferred embodiment, the alert is sent to an e-mail or cell phone number associated with the GPS device. This would typically be the individual associated with the GPS device and serve to warn the individual that they are approaching a restricted region.

Furthermore, a restricted region may be defined in time as well as space. In this case, the region is restricted (active) during certain times but note during other times. In this embodiment, the GPS Location Computer System checks if the GPS device is within the restricted region, and also checks if the region is active at the present time. Here, an alert is sent if the restricted region is active.

Moreover, an alert may be sent when the GPD Device is determined to be within an inactive restrictive region, but when the region is about to become active. Here, a time difference is specified to determine when to send the alert. For instance, an individual carrying the GPS Device may enter an inactive restricted region. When the inactive restricted region is ten minutes away from activating, an alert is sent indicating that the region is nearing activation.

Finally, an alert may be sent when two or more different GPS Devices are located within a specific distance of each other. In this manner a previous victim of a crime may be warned if an offender approaches the current location of the victim. Alternatively, the victim may be notified if the offender approaches his or her house or place of work.

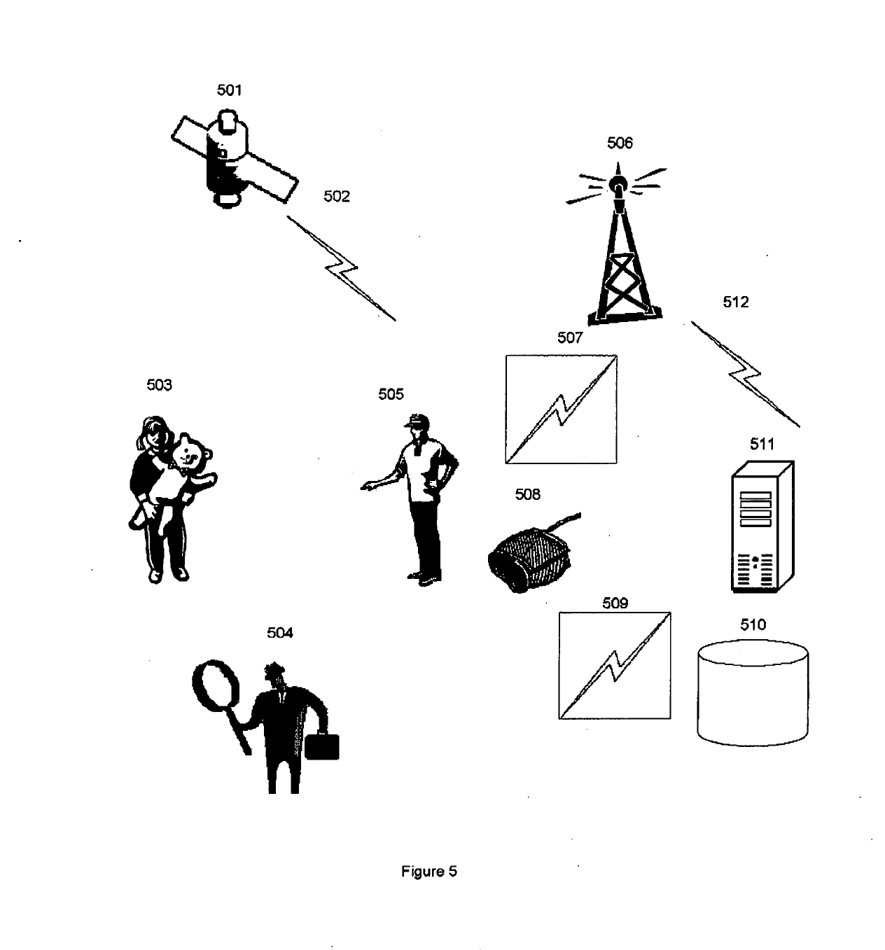

The location system is shown in FIG. 5. FIG. 5 shows a GPS satellite (501) transmitting a GPS signal (502) to a GPS Device (508) attached to a Known Offender (505). The GPS Device (508) transmits a GPS Message (507) to a relaying tower (506) which relays the message (512) to the GPS Location Computer System (511). The GPS Location Computer System (511) stores the messages received in a database (510). The GPS Location Computer System (511) analyzes the data and if necessary, sends an Alert (509) to a Law Enforcement Official (504), and/or the Known Offender (505), and/or a Victim.

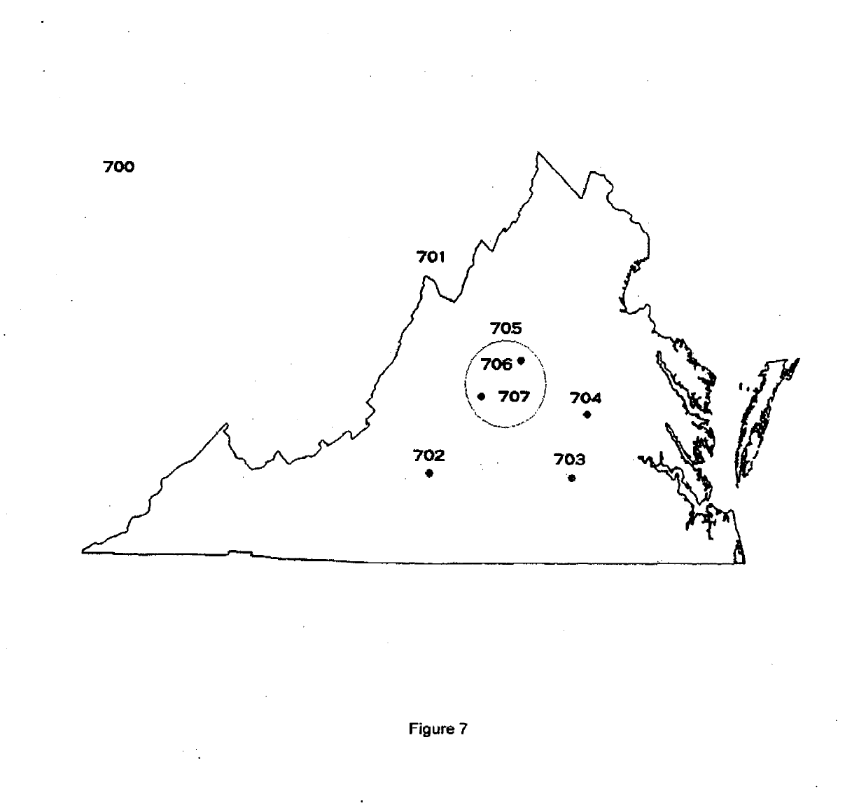

Another embodiment of the Locating System is shown in FIG. 7. Here, the state of Virginia is shown (701), and territory external to the state (700). Several known offenders are shown (706, 707, 704, 703, 702). In this instance, two of the known offenders (706, 707) are located impermissible close to each other. This results in the identification of a forbidden region (705).

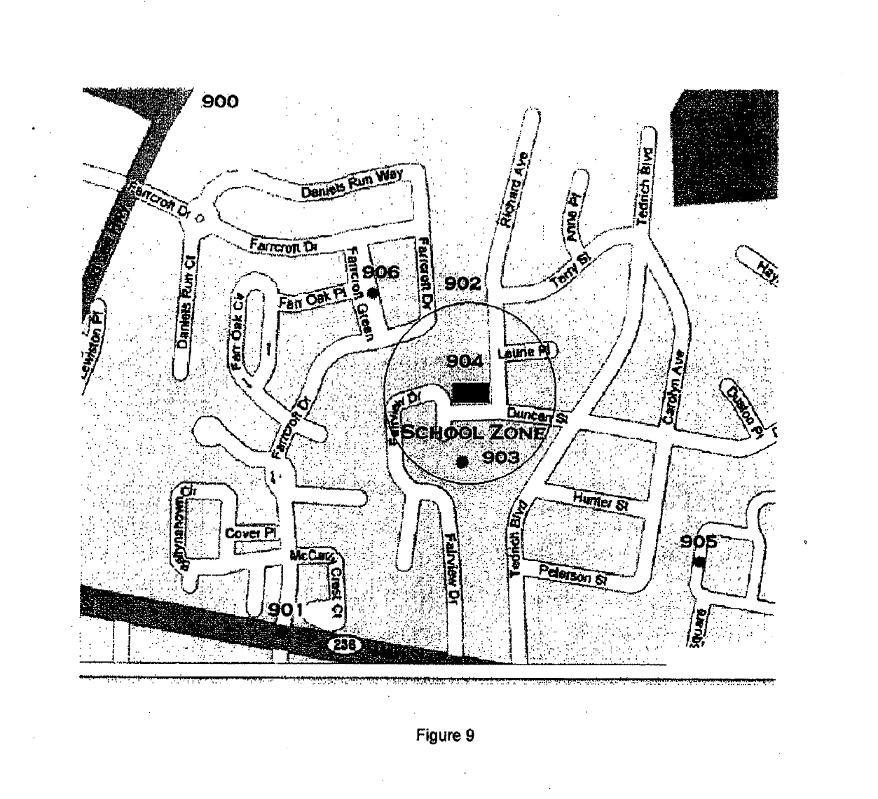

Another embodiment of the Locating System is shown in FIG. 9. Here, various regions of the city are shown. A field (900) is shown along with the Main Street (901) and smaller side streets (906). Two filled circles (903, 905) represent the locations of Known Offenders via the GPS Tracking device. In addition, a School is shown (904) along with a circular School Zone (902). In this instance, one Known Offender is present (903) within the restricted School Zone (902). The other Known Offender is present (905) in a region outside the School Zone (902).

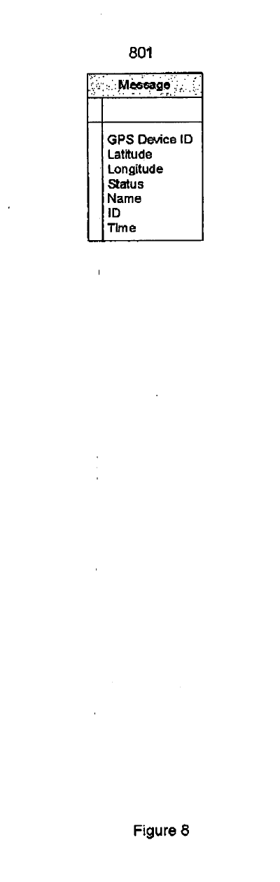

An example of the data in the GPS Message is shown in FIG. 8. Here, the message structure (801) contains information relating to the GPS Device ID, Latitude, Longitude, Status, Name, ID, and Time.

Tracking System

Another embodiment of the invention tracks the movement of the GPS Device. Here, the GPS Location Computer System keeps a record of the location of the GPS Device over time. In this manner, the GPS Location Computer System may later be consulted in order to track the historical movements and location of the GPS Device.

This embodiment all investigators to track the historical movements of a suspect. Thus, if investigators suspect a criminal who uses the GPS Device is responsible for a new crime, the investigators can consult the GPS Location Computer System to determine if the criminal was at the scene of the new crime.

This embodiment also allows a historical review of the pattern of movement of the GPS Device. For instance, it may be discovered that the GPS Device moves to a coffee shop early in the morning, then to a park, followed by one of a few restaurants over lunch, and so on. With this information a reviewer of this information may be able to devise a profile for the movement of the person throughout a typical day. Thus, if the GPS Device becomes inactive, a reviewer may be able to use the tracking information to locate the present whereabouts of the individual associated with the GPS Device.

This embodiment also allows for a historical review of the concurrent locations of a plurality of GPS Devices. For example, a known sex offender may be specifically prohibited from being present at the same location as another known sex offender. This embodiment allows a review to determine if two or more known sex offenders engaged in an impermissible meeting.

This embodiment also facilitates investigation of two or more known sex offenders frequenting the same location. For instances investigators may take note that a known sex offender frequents a specific location that is often later frequented by another known sex offender. The investigators may suspect that the to individuals are engaging in an impermissible contact even though they are not located at the same place at the same time.

The Tracking System may also be used to detect conspirators in a criminal conspiracy. First, a crime is identified. Next, a potential suspect is determined. Next, the historical tracking information is reviewed to determine if the suspect as been in contact with other known offenders. If a contact is found, this evidence supports the possibility that a criminal conspiracy may be present. It should be noted that the contact may occur either before or after the commission of the crime. Furthermore, a conspiracy may be suspected despite the fact that the contacted offenders were not present at the location and time of the commission of the crime.

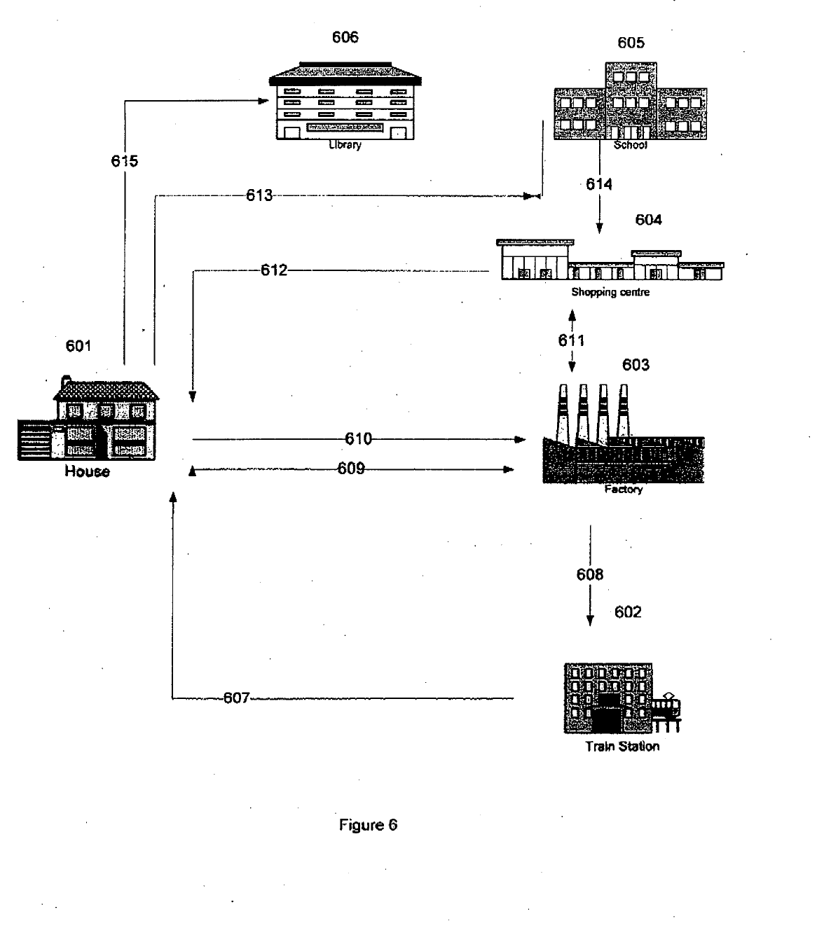

The Tracking System is shown in FIG. 6. Here, the specific movements of a Known Offender are recorded and reviewed. For example, the Known Offender leaves his house (601) and proceeds along an identified route (610) to his job at a Factory (603). Later, the Known Offender returns to his house (601) along a neighboring route (609). Alternatively, the Known Offender may commute (608) to a train station (602) where he takes a train the returns him home along a different route (607). Moreover, the Known Offender may go shopping during lunch at a shopping center (604). Again, his path (611) to and from the shopping center is recorded. Furthermore, the Known Offender may frequent the local library (606) and the path taken (615) is again recorded. Finally, the Known Offender may again go shopping at the shopping center (604). However, this time he takes a forbidden path (613) that travels by a school (605) and then a path (614) to the shopping center (604) before returning home (612).

### OTHER EMBODIMENTS

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the communication lines disclosed herein are intended to represent exemplary functional relationships and/or physical couplings between the various entities. It should be noted that many alternative or additional functional relationships or physical connections may be present in a practical electronic transaction or transmission.

It should be appreciated that the security agent described above may not be present. For instance, the present invention is capable of operating an automated fashion where the individuals desiring entry may themselves present information, such as an ID Card, to the Local System. The Local System carries out a similar process to that described above, then may allow access by automatically unlocking a door providing access to the facility. Otherwise, the Local System may deny entry by not unlocking the door.

It should also be appreciated that the transmitting of updated between the Local System and the Central system may be carried out with various methods. For instance, above is described a pull process where the Local System initiated contact with the Central System in order to obtain updates. The process may be carried out with a push system, where the Central System initiates the contact with the Local System and then the updates are transmitted.

It should also be appreciated that the Local System may be updated by means other than communication with the Central System. For instance, the Local System may be updated via manual entry or via electronic media such as CD, DVD, floppy disk, memory stick, or other media capable of encoding information readable by computer. In the embodiments media is periodically sent to the customer containing update information or the entirety of the Central Data base. The customer presents the media to tie Local System, which in turn updates the Local Database.

It should also be appreciated that the communication lines described above may be of various types. For instance, the Local System may connect to the Central System using a VPN, secured internet connection, private network, static route, point-to-point connection, flame relay, or wireless connection.

It should also be appreciated that the Central System may be updated by any means. For instance, in one preferred embodiment, the Central System is updated by searching online state registries. In another embodiment, the Central System is updated by scanning and OCRing text data or by manual entry. The methods may be preferred because many local police departments provide information on sex offenders not available online. Thus, data may be procured from local police departments and added to the Central Database by manual entry, by scanning and OCRing text data, or other means of entry.

It should also be appreciated that the forms of data scanning by the ID Reader may be by any means. For instance, the data scanning may be OCR from State IDs, magnet stripe reading, barcode reading, fingerprint recognition, voice entry, facial recognition, bio metrics, retinal scan, DNA scans, passport scans, passport barcode scans, passport magnetic scans, passport chip scans, driver license scans, driver license bar code scans, driver's license magnetic scans, driver license chip scans, library card scans, school ID scans, State ID scans, RIFID, and/or GPS Magnetic Dye.

It should also be appreciated that the ID Reader may not identify all information from the State ID. The ID Reader may only be capable of scanning an image of the ID. The software system may then be used to OCR the image and identify the necessary elements. Additionally, the ID Reader may be able to OCR the ID, but may not be capable of identifying the various elements (identifying the first name, middle name, last name, etc.) In this case, the software system may process the information and identify the necessary elements.

It should also be appreciated that the Central System may be comprised of multiple computers, multiple databases, and/or multiple software systems. A distributed computing system has many advantages, such as the ability to update multiple states simultaneously, reducing the total time required to complete an update of the Central Database.

It should also be appreciated that the Web Software may use a variety of methods for notification. Notification may be made via e-mail, pager, account alerts on a website, or automated telephone call.

It should also be appreciated that the Local System may initiate the update process with the Central System in response to an action by the user. For instance, the user may manually click a button from the Local Software which initiates the update process.

It should also be appreciated that the Local System may be designed to stop functioning if an update is not made in a timely manner. For instance, after one month without receiving an update, the Local System may notify the user/customer that the Local System must be updated in order to continue operation. In addition, the Local System may notify the user one or more times before operation is halted in order to warn the user/customer that service may be interrupted.

It should also be appreciated that the Local System may update more or less frequently that daily. This feature may be implemented at the discretion of the user/customer to allow continuous, hourly daily weekly, bi-weekly, monthly, quarterly, yearly, or any other periodic update. The Local System may also be configured to only update when the user/customer initiates the update process.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various entities. It should be noted that many alternative or additional functional relationships or physical connections may be present in a practical electronic transaction or transmission.

It should be appreciated that the communications lines described herein may include any system for exchanging data or transacting business, such as Internet, intranet, extranet, WAN, LAN, satellite communication, cellular phone communications, and the like. Further, the communications between entities concerning the transaction or access request can occur by any mechanism, including but not limited to, Internet, intranet, extranet, WAN, LAN, point of interaction device (point of sale device, personal digital assistant, cellular phone, kiosk, etc.), online communication, off line communication, and wireless connection. The present invention might further employ any number of conventional techniques for data transmission, signaling, data processing, network control, and the like. For example, radio frequency and other wireless techniques can be used in place of any network technique described herein. It is further contemplated that communications can occur sequentially, in parallel, or that two or more communications may be sent as one communication.

It should also be appreciated that the mobile device may be of various characters. This device may a PALM, Pocket PC, laptop computer, tablet PC, text message, SMS or cellular phone.

In each of the above embodiments the different, specific embodiments of invention to identifying sex offenders are disclosed. However it is the full intent of the inventor of the present invention that the specific aspects of each embodiment described herein maya bet combined with the other embodiments described herein. Those skilled in the art will appreciate that various adaptations and modification of the preferred embodiments can be configured without departing from the spirit and the scope of the invention. Therefore, it is to be understood that the invention may be practiced other than that specifically described therein.

It should also be appreciated that the embodiments detailed above are not limited to known sex offenders. Application to known sex offenders represent the preferred embodiment however these systems may be applied to any criminal. Additionally, these systems may be applied in other situations such as the tracking and locating of employees by employers by parents to track children, or by schools to track their students.

It should also be appreciated that the alerts mentioned in the Location and Tracking embodiments may be provided by a number of mechanisms. The alerts may be sent by e-mail, text message, cell phone recording or pager.

It should also be appreciated that the alerts mentioned in the Location and Tracking embodiments may be delivered to a number of different people. Typical recipients may be known sex offenders, convicted criminals, law enforcement officers, parole officers, superintendents principals, teachers, parents, children, supervisors, employees or any other party interested in receiving the alert including other computer systems.

It should also be appreciated that an alert may be sent in the Tracking or Locating embodiment if the GPS Device is tampered with or fails to move over an extended period of time in this manner the GPS Device can be used to send a notification when it appears that the individual associated with the device has disabled or tampered with the GPS Device.

It should also be appreciated that it is not necessary that the individual associated with the GPS Device have knowledge of the presence of the GPS Device. This situation may facilitate a covert investigation of the individual without the specific knowledge of the individual.

We claim:

1. A tracking system to provide for tracking of at least one person, said system comprising:
a) a first portable monitoring device (“GPS Device”), each GPS Device comprising:
1) securing means to provide for secure attachment of said first GPS Device to said person;
2) tamper detection means to provide for detecting tampering with said first GPS Device attached to said person;
3) receiving means to provide for receiving a GPS signal from a satellite;
4) transmitting means to provide for transmission of a first signal from said first GPS Device to a GPS location computer system;
b) GPS location computer system capable of interpreting the transmission of said first signal, identifying said first GPS Device, and determining the location of said first GPS Device.

2. The tracking system of claim 1, whereby said GPS location computer system is further capable of comparing the location of said first GPS Device to a location database, thereby determining if the GPS Device is located within a location stored on said database.

3. The tracking system of claim 2, whereby said location database comprises information selected from the group consisting of: latitude and longitude coordinate position of the location, time restrictions to access location, non-collinear latitude and longitude coordinate positions, identification of individuals who cannot enter location, law enforcement contact information, and mixtures thereof.

4. The tracking system of claim 3, whereby said location stored on a database is a location of a restricted region as defined by a specific latitude and longitude coordinate position along with a radius, and whereby if the GPS Device is located within a restricted region, said GPS location computer system notifies law enforcement.

5. The tracking system of claim 3, whereby said location of a restricted region contains time restrictions for accessing location, and whereby GPS location computer system compares current GMT time to the time restrictions for accessing location to determine said GPS Device is granted access to the location at the current GMT time.

6. The tracking system of claim 1, further comprising at least a second GPS Device attached to a second person, whereby said GPS location computer system is capable of interpreting the transmission of said first GPS Device signal and said second GPS Device signal, identifying said first and second monitoring device, and determining the location of said first and second GPS Device.

7. The tracking system of claim 6, whereby said GPS location computer system compares the location of said first and second GPS Device to find the distance between said Devices, whereby said database comprises information on the impermissible distance of said first and second GPS Device, whereby said GPS location computer system compares the distance between said Devices with the impermissible distance of said first and second GPS Device.

8. The tracking system of claim 6, whereby said GPS location computer system compares a historical tracking data for the first GPS Device with a historical tracking data for the second GPS Device and determines if the devices were located within the same specified region at different times.

9. The tracking system of claim 6, further comprising at least a third GPS Device attached to a third person, whereby said GPS location computer system is capable of interpreting the transmission of said first GPS Device signal, said second GPS Device signal, and said third GPS Device, and identifying said first, second, and third monitoring device, and determining the location of said first, second, and third GPS Device.

10. The tracking device of claim 6, wherein said first person has been convicted of a sex crime, and wherein said second person was a victim of said first person's sex crime.

11. The tracking device of claim 10, wherein an alert is transmitted to said second person when said GPS location computer system determines said first person is within an impermissible distance of said second person.

12. The tracking device of claim 10, wherein an alert is transmitted to one or more law enforcement officials when said GPS location computer system determines said first person is within an impermissible distance of said second person.

13. The tracking system of claim 11, whereby said GPS location computer system compares a historical tracking data for the first GPS Device with a historical tracking data for the second GPS Device and determines if the devices were located within the same specified region at different times.

14. The tracking system of claim 12, whereby said GPS location computer system compares a historical tracking data for the first GPS Device with a historical tracking data for the second GPS Device and determines if the devices were located within the same specified region at different times.

15. A method of identifying criminals comprising the tracking system of claim 1 and the steps comprising:
a) a means for recording the location of the GPS Device over time; and
b) a means for identifying the location and time of a crime; and
c) a means for comparing the location and time of the GPS Device with the location and time of the crime in order to identify if the first person was present at the location and time of the crime.

16. A method of identifying criminal conspirators comprising the tracking system of claim 6 and the steps comprising:
a) a means for recording the location of the first and second GPS Device overtime; and
b) a means for identifying the location and time of a crime; and
c) a means for comparing the location and time of the first GPS Device with the location and time of the crime in order to identify if the first person was present at the location and time of the crime;
d) a means for determining if the first person and second person were in contact before or after the crime and thus potentially conspiring in the commission of the crime.

17. A method of tracking at least one sex offender, said method comprising:
securely attaching a first GPS Device to said sex offender;
providing a method to detect if said first GPS Device is tampered with; receiving a CPS signal from a satellite;
transmitting a first signal from said first GPS Device to a GPS location computer system;
interpreting said first signal;
identifying said first monitoring device;
determining the location of said first GPS Device;
comparing the location said first GPS Device to restricted locations saved within a location database;
determining if the location of said first GPS Device is within a restricted location;
notifying law enforcement if the location of said first GPS Device is within a restricted location.

18. The method of claim 17, whereby said method further comprises:
determining the current GMT time;
comparing the current GMT time to the restricted location information saved within said location database to determine if the location of said first GPS Device is within said restricted location at an impermissible time.

19. The method of claim 17, whereby said method further comprises:
securely attaching a second GPS Device to a second person;
transmitting a second signal from said second GPS Device to said GPS location computer system;
interpreting said second signal;
identifying said second GPS Device;
determining the location of said second GPS Device;
comparing the location said second GPS Device to the location of said first GPS Device;
calculating the distance between said first GPS Device and said second GPS Device;
determining if the location between said GPS Devices is an acceptable distance; and
notifying law enforcement if the location between said GPS Devices is not an acceptable distance
